(19) United States
(12) Patent Application Publication
(10) Pub. No.: US 2004/0076848 A1
(43) Pub. Date: Apr. 22, 2004

(54) Method and apparatus for obtaining a resilient impression of a body part or other form, and the completed cast created therefrom

(76) Inventor: Lee A. Shirer, Homewood, IL (US)

Correspondence Address: MCCRACKEN & FRANK LLP, 200 W. ADAMS STREET, SUITE 2150, CHICAGO, IL, 60606, US

(21) Appl. No.: 10/274,645

(22) Filed: Oct. 19, 2002

(51) Int. Cl. B29C 33/40

(52) U.S. Cl. 428/542.8; 264/222

(57) ABSTRACT

A method, apparatus, and product formed by applying the method to the apparatus for obtaining an accurate impression of a body part or other form. The impression is obtained using a casting blank formed of a thermoplastic material that is resiliently rigid at room temperature and malleable when heated to low temperatures above room temperature. The casting blank is heated until suitably malleable, applied adjacent the body part or form to obtain an impression, cooled until suitable resiliency returns to create a completed cast, and the completed cast then removed from the body part or form. The completed cast may then be used to form subsequent impressions by repeating the same process, substituting the prior completed cast for the casting blank.

### FIELD OF THE INVENTION

The present inventions relate generally to prosthetic devices and methods of manufacturing prosthetic devices, and more particularly to obtaining an accurate mold of a body part using a thermoplastic casting blank.

### BACKGROUND OF THE INVENTION

In the prosthetics field, it is usually necessary to form a socket portion of a replacement limb to comfortably fit the residual limb of the patient. In so doing, it is desirable to size and form the socket-limb interface surface such that the interior contours of the socket closely approximates the natural exterior contours of the residual limb. This is necessary in order to maximize the comfort of the patient, who will be wearing the prostheses for extended periods of time, and to minimize unnecessary stresses on the prosthesis and thereby cause it to have superior structural integrity.

In order to achieve a well-fit prosthesis socket, it is customary in the art to make a negative impression—or mold—of the patient's residual limb. This has traditionally been done using some sort of plaster, clay, epoxy resin, fiberglass, or other similarly formable material, and thereby obtain a temporary negative mold of the residual limb. From the negative mold, positive molds may then be cast from which the actual prosthesis socket can later be molded. By this process, it is possible to create a prosthesis-limb interface surface that almost exactly duplicates the natural contours and volume of the residual limb. However, these known methods and materials can be very messy and difficult to work with, thereby taking more time to complete. Furthermore, because of their unyielding rigidity, it is often difficult to remove the cast from over the contours of the limb without damaging the cast. Also, such casts cannot be readily reused to make subsequent castings.

A more recent method of duplicating the contours of the residual limb uses digital imagery and digital mapping to create a computer generated model of the patient's residual limb. From this digital map, a mold of the patient's limb's contours can then be constructed using sophisticated lathing equipment that is controlled by computer driven software. The equipment and specialized training necessary to operate these devices to create the molds, however, can be very expensive.

A thermoplastic casting blank is known for taking an impression of an existing prosthesis socket. However, this blank is unsuitable for directly obtaining an impression of the residual limb because it's plasticity point is at a temperature too hot to be comfortable to the touch. Furthermore, at the required plasticity temperature, the thermoplastic does not retain enough elasticity to effectively retain the contours of the residual limb. Finally, the thermoplastic used has very little elastic memory, and therefore, it cannot be effectively cast more than once. Until now, it was unknown how to provide an accurate mold of a residual limb using a thermoplastic casting blank, which is resiliently rigid at room temperature, but is malleable when heated to a temperature comfortable to a person's skin, and also retains sufficient elasticity while heated to suitably accept an impression.

### SUMMARY OF THE INVENTION

The object of this invention is to provide a simple and inexpensive apparatus and process for obtaining an impression of a body part that can be applied directly to the skin and is both faster and easier to use than the existing art. Another objective of this invention to provide such a casting device that can be used to obtain multiple subsequent impressions. A further objective if this invention to provide a method and device that does not require highly specialized machines, training, or working conditions.

To that end, one aspect of the invention herein is a thermoplastic casting blank that is appropriately sized to fit about a desired body part or other form. The casting blank is readily formable when heated to a temperature below the boiling point of water and yet retains enough elasticity to obtain an accurate impression of the form. By reaching its plasticity point at a low temperature, the casting blank may be applied directly to the skin of a patient without undue discomfort. Due to the elastic memory of the thermoplastic used at the necessary temperature for obtaining the impressions, the casting blank may be used multiple times to make multiple impressions.

Another aspect of the invention herein is a process for obtaining a negative impression of a desired body part. The casting blank is heated to a sufficient temperature and applied to the body part or other form desired to be cast. A set cast is then formed by maintaining the casting blank against the body part such that an accurate impression is obtained. The set cast is then cooled until it regains a desired rigidity similar to the rigidity of the original casting blank, thereby becoming a completed cast. Finally, the completed cast is removed from the body part.

Yet another aspect of the invention is the completed cast created by the process described above. The completed cast, being the same material as the original casting blank, has the unique ability to be recast to accept another impression at a later time using the same process as described above, except that a previously completed cast is substituted for the casting blank. Therefore, the completed cast may be re-cast repeatedly without any known limit, while continuing to maintain the properties set forth above.

In the preferred embodiments, the invention is used in the prosthetics field to obtain a negative impression of a patient's residual limb directly from the residual limb. From the resulting mold, subsequent steps in the process of making a prosthesis can proceed. The preferred casting blank is a conically shaped sidewall with an inner surface, an outer surface, an apex at the smaller diameter end with a small hole through the sidewall, and an open end at the larger diameter end. The casting blank is sized such that the inside diameter of the open end is approximately equal to, or slightly smaller than, the outside diameter of the residual limb to be cast. The preferred process includes heating the casting blank in warm water maintained at a temperature of 150 degrees Fahrenheit until the blank turns from opaque to translucent; removing the blank from the water and draining any excess water therefrom; placing the blank against the patient's skin to ensure that the temperature is not uncomfortably hot; forming the blank around the residual limb to be cast; cooling the resulting set cast with cool water until it is sufficiently rigid; and removing the completed cast from the patient's residual limb. The completed cast can then be reused an unlimited number of times to make subsequent impressions by repeating the described process accordingly. It is to be understood that, while this is the preferred embodiment of the invention, variations of any of the described portions may be used to achieve the same end, and the invention is not limited to the description of the preferred embodiment.

### BRIEF DESCRIPTION OF THE DRAWINGS

FIG. 1 is a perspective view of a casting blank.

FIG. 2 is a cross sectional view illustrating a method of heating the casting blank.

FIG. 3 illustrates a method of creating an impression of a residual limb.

FIG. 4 illustrates a method of rapidly cooling the cast.

FIG. 5 illustrates the cast obtained by the method represented in FIGS. 2 through 4.

### DETAILED DESCRIPTION OF THE ILLUSTRATED EMBODIMENT

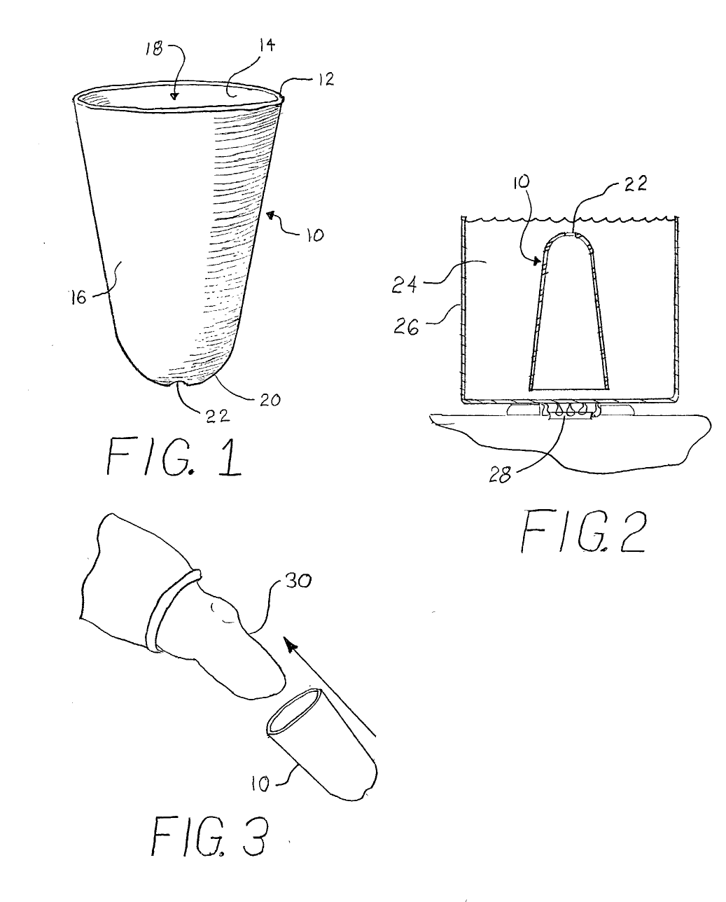

FIGS. 1 through 5 depict the casting blank and the molding process (10) in its preferred embodiment as required to make a negative impression of a residual limb below the knee (30). The casting blank (10) comprises a sidewall (12) having an inner surface (14) and an outer surface (16). The sidewall (12) is conically shaped with an opening (18) for receiving a residual limb and a rounded apex (20). The apex (20) is located at the smaller diameter end of the conical sidewall (12) and the opening is located at the larger diameter end of the conical sidewall (12). A drain hole (22) through the sidewall is located in the apex (20) and allows air and water to vent through the sidewall when heating and forming the casting blank (10).

The casting blank (10) is sized such that the inside diameter of the opening (18) is slightly smaller than the outside diameter of the residual limb (30), and the length is sufficient to obtain as long a casting as is necessary to make the final prosthesis. Therefore, different lengths and diameters may be used to cast differently sized body parts. The sidewall (12) has a constant thickness of about 3 millimeters throughout its entirety. Other thicknesses may be used for different sizes or shapes of casting blank (10), depending on the desired application. A thicker sidewall (12) may be used to increase the circumferential elastic tensile stresses (32) during the molding process, however, although a thinner sidewall (12) could be used, it is not recommended because the corresponding decrease in circumferential elastic tensile stress (32) during the molding process can negatively impact the molding process.

The casting blank (10) is composed of a thermoplastic material that is resilient, or semi-rigid, at room temperature, but which becomes easily malleable at a temperature below the boiling point of water while retaining enough elasticity to effectively form and maintain an impression of a residual limb or other form with its own elasticity. In the preferred embodiment, the thermoplastic material becomes malleable at a temperature of approximately 118 degrees Fahrenheit and turns from an opaque color to translucent when heated to a temperature of approximately 145 degrees Fahrenheit. When thus heated, the material may be molded about a form to accept the impression of the form, and the material retains enough elasticity so as to tensiley resist when stretched. Upon cooling, the material returns to its original opaque appearance and regains a certain degree of stiffness so that the blank retains an accurate molded impression of the form and also has sufficient resiliency to allow the material to be momentarily deflected or flexed and substantially return to its exact molded shape when released. The material has an elastic memory such that if stretched or otherwise formed during one heating/molding process, the formed area will return to its original shape when reheated, thus enabling the material to be reused to make different subsequent molds. Unlike plaster or fiberglass casting techniques, the flexibility of the material when cooled allows the completed cast to be easily slid over the contours of the residual limb, and the material does not adhere to the hairs on the residual limb. Accordingly, the material has a flexural modulus between 40,000 and 200,000 psi, and preferably of approximately 120,000 psi, when at room temperature. In the preferred embodiment, the casting blank is composed of a low temperature thermoplastic, such as the material manufactured and marketed by Chesapeake Medical Products, Inc. under the tradename REBOUND, and is coated with a non-stick coating to facilitate easy transfer from the molds and from the form.

In order to obtain a completed mold (36) of the residual limb (30), the casting blank (10) is heated until the thermoplastic changes from opaque to translucent, but not so hot as to be uncomfortable to the touch of bare skin. In the preferred method, the casting blank (10) is heated by submerging it into a pot (26) filled with water (24) that has been heated by a heat source (28) to a temperature of approximately 150 degrees Fahrenheit. Thus limiting the temperature of the water (24) ensures that the casting blank (10) will not be overheated so as to be uncomfortably hot to the touch. Other methods of heating the casting blank (10) could utilize hot air blown onto the casting blank (10), a convection oven, microwave energy, or any other known means of heating the casting blank (10) to the necessary temperature. In the preferred method, the change from opaque to translucent usually takes from between 1 to 10 minutes, but this time will vary depending on the size of the casting blank and the temperature of the heat source.

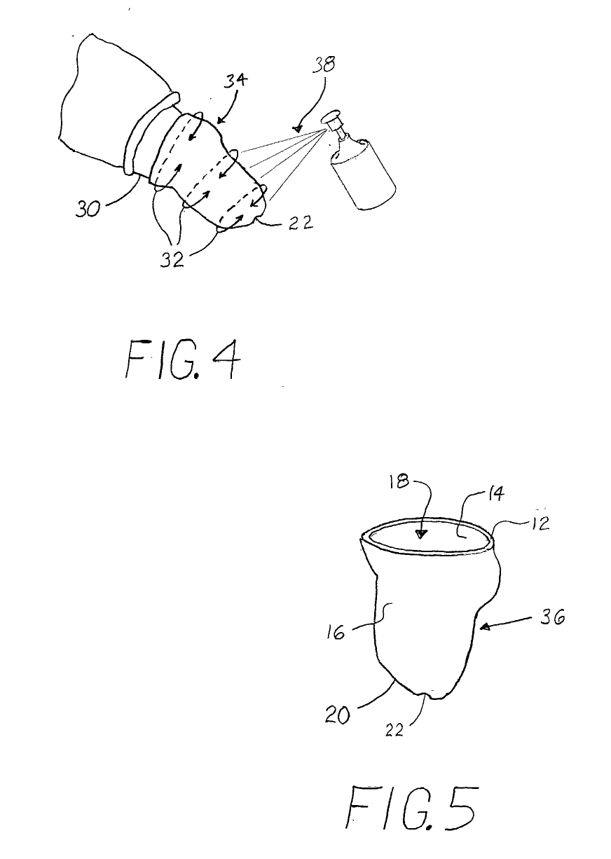

After the casting blank (10) turns translucent, it is removed from the water (24) and any excess water is allowed to escape from the interior of the casting blank (10). The temperature of the casting blank (10) is then checked by touching it to the skin of the patient to ensure that it is not dangerously or uncomfortably hot. The heated casting blank (10) is then pulled, stretched, or otherwise molded over the residual limb (30) to form a set cast (34) as shown in FIGS. 3 and 4. If properly sized, the elastic circumferential tension (32) created by stretching the blank over the residual limb (30) is sufficient to cause the blank (10) to snugly fit directly adjacent the contours of the residual limb (30) and thus obtain an accurate impression of the residual limb (30). When thus using a properly sized casting blank (10), no external compression or suction is required for the set cast (34) to adopt the contours of the residual limb (30), but such may be used if so desired.

The set cast (34) is then allowed to cool while remaining on the residual limb (30) until it again becomes resiliently rigid, thereby becoming a completed cast (36). In the preferred embodiment, the set cast (34) is doused with cool water (38) in order to shorten the cooling time. After the completed cast (36) becomes sufficiently resiliently rigid again, it is removed from the residual limb (30). The completed cast (36) may then be used as necessary in the manufacture of the final prosthesis.

The first completed cast (36) thus obtained from molding a casting blank (10) as described above also has the unique ability to be remolded to obtain a second or subsequent completed cast (36). Such remolding is accomplished by repeating the method described above for obtaining a completed cast (36), but substituting the completed cast (36) in place of using a casting blank (10).

This device and method could be used to obtain rigid impressions of nearly any part of the body or other form for any reason by simply adjusting the shape and size of the casting blank. Therefore, for example, an appropriately sized hemispherical casting blank (10) could be used to obtain a cast of a baby's skull for creating a protective helmet. Another example might be to use an appropriately shaped and sized casting blank (10) to obtain an impression of an existing prosthesis mold. Another example might be to use an appropriately shaped and sized casting blank (10) to create a temporary splint for a broken bone, or for forming a post-operative rigid dressing such as is used to temporarily protect and reduce edema—or swelling—in a residual limb after amputation. Another example might be to use an appropriately shaped and sized casting blank (10) to obtain a negative impression of a person's face. Other variations on the uses, sizes, and shapes of the invention are anticipated and specifically included as part of this invention by the inventor. Therefore, the specific device and method depicted in FIGS. 1 through 5 and described herein is the inventor's preferred embodiment, and is not meant to serve as a limitation, but as an example only, since variations and modifications to the invention described would be obvious to a person skilled in the art.

I claim:

1. A casting blank comprising:
a sidewall sized to fit snugly adjacent a form, the sidewall having an interior surface and an exterior surface;
the blank being formed of a thermoplastic material having a flexural modulus between approximately 40,000 psi and 200,000 psi;
the blank further being resiliently rigid at room temperature, becoming malleable when heated to a temperature below 212 degrees Fahrenheit such that the sidewall will conform to the contours of said form and yet maintain enough elasticity so as to exert a necessary amount of tensile stress when stretched, and becoming resiliently rigid again when cooled back to room temperature so as to maintain an accurate impression of the form.

2. The casting blank of claim 1 wherein the blank further comprises the characteristic of elastic memory.

3. The casting blank of claim 1 further comprising a non-stick coating on the interior and exterior surfaces of the sidewall.

4. The casting blank of claim 1 wherein the blank becomes malleable at a temperature below 200 degrees Fahrenheit.

5. The casting blank of claim 1 wherein the blank becomes malleable at a temperature of approximately 118 degrees Fahrenheit.

6. The casting blank of claim 1 wherein the sidewall is opaque when at room temperature, becomes translucent when heated, and returns to opaque when subsequently cooled.

7. The casting blank of claim 1 wherein the side wall has a constant thickness and is initially formed in a generally conical shape with a first end having a smaller inside diameter and a second end having a larger inside diameter; the first end having a rounded apex with a hole through the sidewall; and the second end being open with an inside diameter sized for fitting snugly about said form.

8. The casting blank of claim 1 wherein the thermoplastic material consists of the product manufactured by Chesapeake Medical Products, Inc. and marketed under the name, REBOUND.

9. A method of obtaining an accurate impression of a body part using a casting blank that is resiliently rigid at room temperature, becomes maleable when heated to a temperature below 212 degrees Fahrenheit with sufficient elasticity to exert a necessary amount of tensile stress when stretched, and becomes resiliently rigid again when cooled back to room temperature, wherein the method comprises the steps of:
heating the casting blank until it is easily malleable;
fitting the casting blank snugly to the body part so as to closely follow the contours of the body part, thereby obtaining a set cast of the body part;
allowing the set cast to cool until it becomes suitably rigid to retain an accurate impression of the body part, thereby creating a completed cast of the body part; and
removing the completed cast from the body part.

10. The method of claim 9 wherein the casting blank is heated by submersing the casting blank in water maintained at a temperature of about 150 degrees Fahrenheit until the casting blank changes from opaque to translucent.

11. The method of claim 9 further comprising touching the blank after heating but before fitting to the body part so as to ensure that the temperature is not dangerously hot to the body part.

12. The method of claim 9 further comprising accelerating the cooling of the set cast by washing the set cast with cool water.

13. The completed cast obtained from the method of claim 9.

14. The completed cast of claim 13 wherein a previously formed completed cast is used in lieu of a casting blank.
